(19) United States
(12) Patent Application Publication
(10) Pub. No.: US 2016/0267233 A1
(43) Pub. Date: Sep. 15, 2016

(54) DECISION MAKING AID

(71) Applicant: Skip Weitzen, Dana Point, CA (US)

(72) Inventor: Skip Weitzen, Dana Point, CA (US)

(21) Appl. No.: 14/645,011

(22) Filed: Mar. 11, 2015

(51) Int. Cl. G06F 19/00; G06F 17/30

(52) U.S. Cl. CPC G06F 19/345; G06F 17/30867; G06F 19/3425

(57) ABSTRACT

A decision-making aid can be implemented via a computer application and includes a list of medical issues displayed on a medical issue list page. A treatment strategy questionnaire can have each medical issue in a list of medical issues formed as a link to a particular treatment strategy questionnaire. The treatment strategy questionnaire includes a list of questions, and each question of the list of questions can be displayed on a question page. A prompt receives an answer to each question. A query is preferably presented as a yes button and a no button. The prompt is a yes or no prompt corresponding to the yes button and the no button. The yes button provides a yes prompt response, and the no button provides a no prompt response.

### FIELD OF THE INVENTION

The present invention is in the field of emergency room decision-making aids.

### DISCUSSION OF RELATED ART

Considering a large enough set of emergency room visits often shows a routine pattern, emergency room physicians often need to ask the same clinical questions over and over again. These questions could be asked by a nurse, a physician assistant or even by the patient themselves, but the physician could be concerned that the assistants might forget to ask some of the questions.

A variety of different methods have been suggested for facilitating rapid and automatic emergency triage of multiple patients. Most of these rely upon a cumulative point total by taking into account various different factors. For example, in U.S. Pat. No. 6,786,406, filed Mar. 28, 2003 the patient information, including vital signs and patient data, is input and analyzed for determining the proper course of treatment. Inventor Levy in U.S. Pat. No. 7,076,437 filed Oct. 27, 2000 provides a process for consumer directed diagnostic and healthcare information that calculates a likelihood ratio depending upon various factors. Inventor Jedwab in U.S. Pat. No. 8,696,568 provides a method for screening a patient for dysphagia risk by scoring a questionnaire of a patient and using a cumulative point total from the questionnaire to determine a diagnosis, and then choosing a proper treatment product based upon a cumulative point total.

### SUMMARY OF THE INVENTION

A decision-making aid can be implemented via a computer application and includes a list of medical issues displayed on a medical issue list page. A treatment strategy questionnaire can have each medical issue in a list of medical issues formed as a link to a particular treatment strategy questionnaire. The treatment strategy questionnaire includes a list of questions, and each question of the list of questions can be displayed on a question page. A prompt receives an answer to each question. A query is preferably presented as a yes button and a no button. The prompt is a yes or no prompt corresponding to the yes button and the no button. The yes button provides a yes prompt response, and the no button provides a no prompt response.

A referral indicator can be displayed to guide the user. The query can be configured to display the referral indicator when a user selects a first preconfigured response to the query. A treatment indicator can be provided, and the query can be configured to display the treatment indicator when a user selects a second preconfigured response to the query. A treatment information page provides medical information regarding a medical issue in the list of medical issues.

The list of medical issues includes a list of patient complaints. The question can be a contraindication or correspond to a contraindication suggesting against a particular type of treatment. A quiz can be provided for the user on numerous quiz pages that have quiz questions. The quiz can be accessed through a quiz link on the treatment page. The quiz is preferably multiple-choice. The query after receiving the yes prompt response or the no prompt response links to either: a next question page; a referral page; or a treatment page. The treatment page has a treatment indicator. The next question page has a next question. The referral page has a referral indicator.

The query can be presented as the yes button and the no button links to a second query also having the yes button and the no button. The second query links to a third query which also has the yes button and the no button. A user can answer the first query, the second query and the third query using the yes button and the no button links.

### BRIEF DESCRIPTION OF THE DRAWINGS

FIG. 1 is a logical diagram of the present invention which can be displayed as a strategy graph on a strategy graph page.

FIG. 2 is a diagram of the question page showing a sample layout of the question page.

FIG. 3 is a diagram of the treatment page showing a sample layout of the treatment page.

FIG. 4 is a diagram of the application navigation showing the quiz and list of medical issues.

FIG. 5 is a diagram of the application navigation of a single topic with arrows denoting links between pages.

FIG. 6 is a diagram of the ENT head and throat complaint category with arrows denoting links between pages.

The call out list of elements can be a useful guide for referencing the elements of the drawings.
108 Category Prompt Entry
101 First Question
102 Second Question
103 Third Question
104 Fourth Question
105 Fifth Question
106 Treatment Protocol
107 Referral Protocol
111 Second Question Prompt Entry
113 Third Question Prompt Entry
115 Fourth Question Prompt Entry
117 Fifth Question Prompt Entry
119 Treatment Protocol Prompt Entry
112 First Question Referral Prompt Entry
114 Second Question Referral Prompt Entry
116 Third Question Referral Prompt Entry
118 Fourth Question Referral Prompt Entry
120 Fifth Question Referral Prompt Entry
121 Question Page
128 Back Button
130 Topic Field
131 Question Number Field
132 Question Text Field
133 No Answer Button
134 Yes Answer Button
135 Information Button
136 Treatment Indicator
137 Treatment Indicator Text
138 Diagnosis
139 Treatment Page
140 Referral Page
141 Referral Indicator Text
142 Referral Indicator
150 Screen Text
151 Logo Text
152 Policy Introduction
153 Healthcare Disclaimer
154 About Text
155 Exam Results
156 Clinical Baseline Exam
157 Exam Question 1
158 Exam Complete
159 Sore Throat—Basics
160 Sore Throat
161 Previous Quiz Question

### DETAILED DESCRIPTION OF THE PREFERRED EMBODIMENT

A computer such as a handheld tablet computer can provide a platform for software that provides a quick decision-making aid for emergency situations such as for emergency department professionals such as physicians, residents, nurse practitioners and physician assistants. A software application can be installed on a tablet computer such as a smartphone. The software application can be implemented with or without a server.

The application is implemented on a device such as a handheld device like a smart phone. The application launches from a user interface. The application begins with a categorized list of the most common emergency room medical issues. The list of categories have text describing the medical issue and the text can be associated with a link. The link is a query that accepts an input such as a touchscreen tap. When a user taps on a particular medical issue on a touchscreen, the user provides a touchscreen input to a category prompt entry 108. The list of medical issues can be arranged as a list of category prompts in a vertical array. The category prompt entry brings the user to a first question 101. The first question is the beginning of a treatment strategy. The treatment strategy may have only one question or may have more than one question.

The application preferably provides a separate screen for each question so that each question is considered independently. The five questions collectively have five separate screens. The first question has a first question screen. The second question has a second question screen. The third question has a third question screen. The fourth question has a fourth question screen.

The fifth question has a fifth question screen. The referral protocol has a referral protocol screen. The treatment protocol has a treatment protocol screen. Each question screen has a question query that is preferably in the form of a pair of buttons, color-coded to clearly relate to either a yes or no response. Each button has an active field that can be activated such as by pressing or tapping. Pressing or tapping the buttons provide the prompt entries. After receiving the prompt entries, the application links to other screens according to the treatment strategy. The color-coded buttons can be links to other screens. The screens can be static without moving graphics such that the screens can be characterized as pages such as pages of a document like an electronic document.

The user answers yes or no to the first question 101. A pair of prompts, namely a no prompt and a yes prompt correlate with a second question prompt entry 111 and a first question referral prompt entry 112. If a user answers no to the first question 101, the user taps on the screen to enter a touchscreen tap entry into the no prompt which will provide a second question prompt entry 111. Then the second question prompt entry 111 activates a link that changes the screen so as to display the second question 102 to the user. On the other hand, if the user answers yes to the first question 101, the user taps on the screen to enter a touchscreen tap entry to the yes prompt which will provide a first question referral prompt entry 112 which displays a referral protocol 107 to the user. In this case, the first question could be a contraindication for treatment protocol 106 to be suggested.

The second question 102 can similarly be a contraindication for treatment protocol 106. The second question 102 can receive a second question referral prompt entry 114 if the second question is answered yes. The second question referral prompt can be formed as a red rectangular button on a white background on a touchscreen that can be tapped so that the second referral prompt has a potential second referral prompt entry 114 which is a tap or longer keypress that provides the user a means to enter an input. The user can quickly and easily check multiple contraindications without needing to consult with a physician until the application tells the user to do so. The second referral prompt entry 114 preferably activates a link to change a screen so that the user sees the referral protocol 107 screen.

Similarly, the third question 103 can be accessed by a link when a third question prompt entry 113 is provided. The third question 103 can have a text question in the middle of a screen with black text on a white background. The third question 103 can have a pair of answers, namely yes and no displayed as a pair of rectangular buttons, with the no button being a green button and with the yes button being a red button.

The no button can be a fourth question prompt that receives a fourth question prompt entry 115 when tapped. The yes button can be a third question referral prompt that receives a third question referral prompt entry 116 when tapped. The fourth question prompt entry 115 can link to the fourth question screen having the fourth question 104. The fourth question 104 can also be a contraindication for treatment protocol 106. The fourth question referral prompt entry 118 is checked when the user enters it in the yes button of the fourth question prompt.

The fifth question prompt entry 117 activates a link to the fifth question screen. The fifth question 105 is on the fifth question screen. The fifth question 105 can be the last contraindication for treatment protocol 106. Once the last contraindication is checked, the fifth question referral prompt can receive a tap from the user on the touchscreen to provide the fifth question referral prompt entry 120. Upon receiving the fifth question referral prompt entry 120, the application shows that a contraindication has been found and automatically links to the referral protocol 107 shown on the referral protocol screen.

If the answer to the fifth question prompt is no, the treatment protocol prompt entry 119 is input and the application automatically links to the treatment protocol screen to display the treatment protocol 106. It is preferred that in all of the five questions that the question prompt is a yes or no answer. This is designed to provide a faster response. It is also preferred that the question prompt have a color-coded yes or no in red and green to suggest to the user that a contraindication is being examined. Preferably, when a list of contraindications are being checked for, only the last question has the treatment protocol prompt to receive the treatment protocol prompt entry 119.

If a user does not understand the question, an information page is provided on an information screen accessed by an information button. The information button can be presented on the screen next to the question prompt. The information button can be formed as a circular blue dot with a white italicized lowercase ‘i’ in the foreground.

A question page 121 can be displayed on a screen such as a touchscreen of a smart phone. The screen generally has a back button 128 to go back to the previous screen. The question page 121 preferably includes a topic field 130 which displays the topic selected from the list of categories to define the medical issue. The topic can be displayed as a text or picture or both. Additionally, a question number field 131 can be added so that the user knows which question the user is on. This provides a context for the user. The question text field 132 can be placed below the question number field 131. The question is presented as question text in the question text field 132. The user can answer the question by pressing the no answer button 133 or the yes answer button 134. Pressing the button provides a response to the query. The information button 135 can be placed next to the question answer buttons.

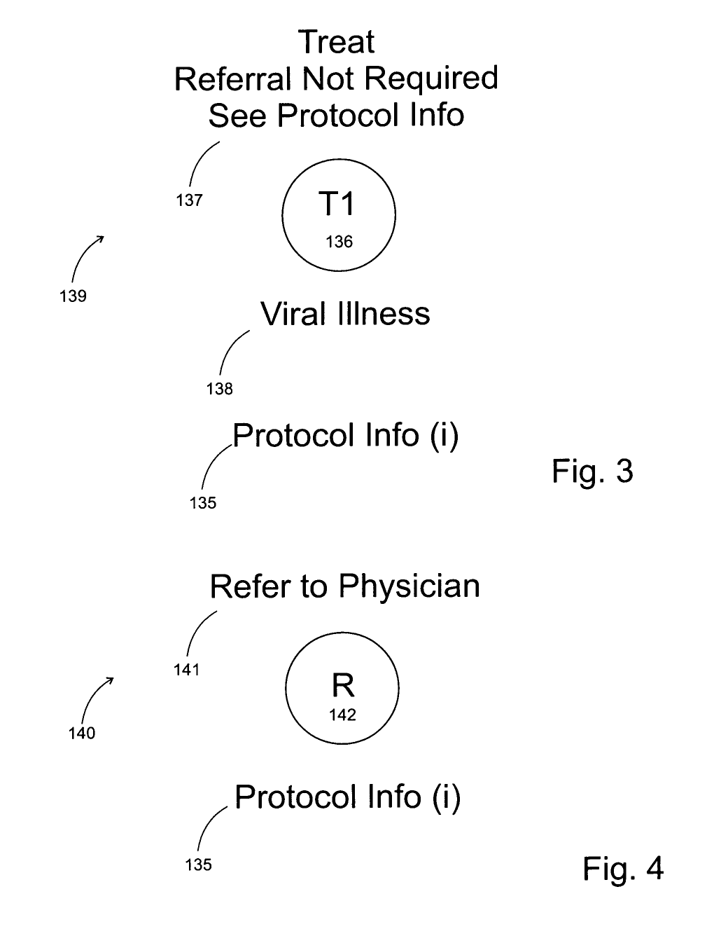

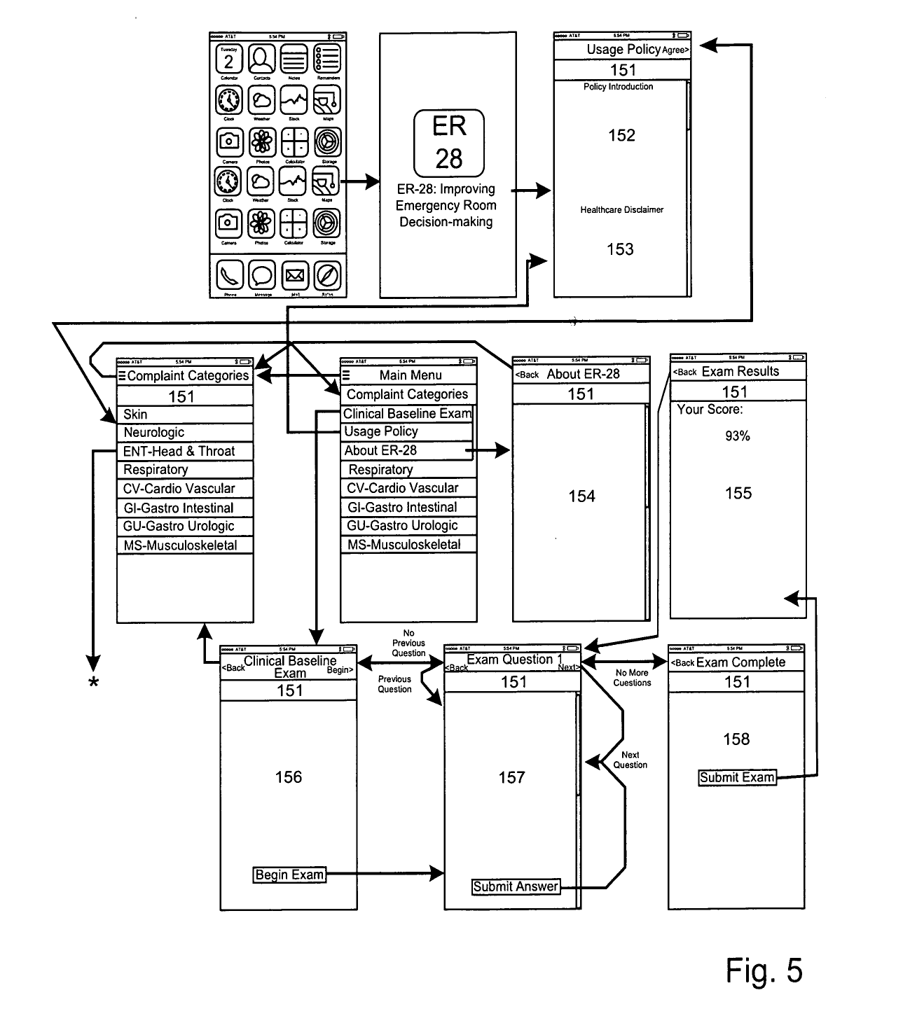

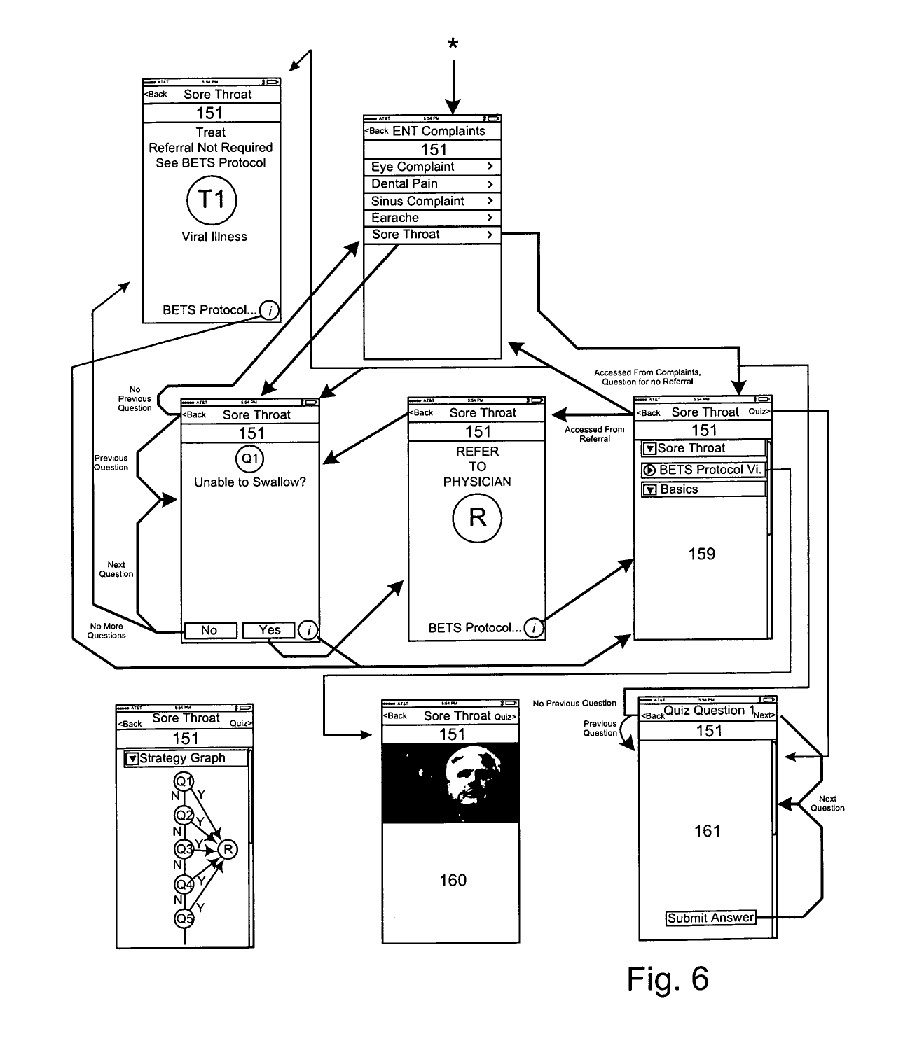

The information button 135 can also be displayed on the treatment page that displays the treatment protocol 106. The treatment protocol 106 includes a treatment indicator 136 which may be in the form of an icon such as a green circle background with a numbered code foreground to show that treatment can be performed. The treatment indicator 136 is preferably displayed on a contrasting background of the treatment page 139. The treatment indicator 136 is displayed with the diagnosis 138 and preferably with the treatment indicator text 137. As shown in FIG. 3, the treatment indicator text 137 can include a phrase such as, “Treat, referral not required, see protocol info”. The treatment indicator 136 can include a code such as “T1” in a foreground with a green background. The protocol info button can be a rectangular field having the text “protocol info (i)”. Pressing the protocol info button provides a tap input to the query graphically represented as a button so that the button links to an information page.

Preferably, the information page includes a link to a video, and a discussion of the medical issue selected from the original categorized list of medical issues. The medical issue includes background information provided by a physician. For example, for the medical issue of “sore throat”, the information page contains a link to a training video on sore throat and additional text of background information. For example, the background information can read, “In Adults, the vast majority of sore throats are Viral and DO NOT require any treatment. Children have a higher incidence of Strep Pharyngitis. Children often present with classic physical signs for Viral Syndromes such as Hand Foot and Mouth Disease. Adolescents are at increased risk for Pharyngitis caused by Epstein-Barr Virus.” A training video may include a video of the physician explaining the basics of treating a sore throat.

A referral page 140 preferably includes a referral indicator text 141 and a referral indicator 142. The referral indicator text 141 can be a short phrase such as, “Refer to Physician” and the referral indicator can be a short symbol such as the letter “R” in a red circle.

The information page can also include a link to a quiz. The quiz can assist in improving clinical knowledge either as a study aid, or as a test to ensure that the user is paying attention to the questions, video and information page. The results of the quiz can be useful. Quiz results can be sent to a server for analysis and archival. The quiz results can be displayed to the user after the user takes the quiz. The quiz results can be displayed on a quiz result page. A percentage score and evaluation can be displayed also on the quiz result page, or by following a link from the quiz result page.

The application does not require that the user is logged in with a username and password. The application does not require a server. The application can contain all of the content as a standalone application. However, it may be preferable for the application to connect to the server so that the application data can be automatically updated according to new clinical guidelines.

The list of medical issues can be shown as a list of complaints. The list of complaints can have categories which may also have subcategories. For example, the complaint category of “ENT—Head & Throat” can have “ENT Categories”. The subcategories can be a list of ENT complaints such as eye complaint, dental pain, sinus complaint, ear ache, sore throat. The subcategories can be a list of links that link to treatment strategy pages arranged according to the strategy graph.

Screen text 150 is displayed on the various pages of the application such as the treatment page. A logo text 151 can be added as a heading for example as “ER-28 Improving Emergency Room Decision Making” to provide a title to the graphical user interface. The logo text can appear on each page of the application. An introductory page may include a policy introduction 152. Policy introduction 152 text can read, “Welcome to the ER-28 App, an information and communications service provided by Dr. Adrian de la Torre MD. Co-founder ER-28. This policy is intended to cover the uses for all of this app and its associated website, although additional conditions, restrictions and privacy policies may apply.” Additionally, an introductory text can include a healthcare disclaimer 153. The healthcare disclaimer 153 can read, “The content is here to educate midlevel professionals on emergency room health care and medical issues, Nothing in the content, products or services should be considered or used as a substitute for, medical advice.” The introductory page or pages can further include an about text 154.

The about text 154 can read, “ER-28 is a mobile app for Midlevel Emergency Department Professionals to quickly access and learn cost-effective Streamlined evaluation and management protocols for the most frequent presenting complaints. Emergency Medicine specialist Dr. Adrian de la Tone MD presents this wealth of information in a form optimized for real world use. Physicians, Residents, Nurse Practitioners and Physician Assistants can use ER-28 to assist the provider with ambulatory patients to improve Efficient and quality of care.”

After the quiz, the application can display exam results text 155. The exam results text also provides a way to tell the user how they did and what else they can do. Exam results text 155 can read, “You can go back to review the exam questions along with the evaluation of your answers. Tap the ER-28 logo button in the banner 151 at any time to begin using this app.” Before the short quiz, the application can display a clinical baseline exam text 156 to give instructions to the user, “This exam assesses your proficiency with the ER-28 BETS Protocols (Basics, Evaluation, Treatment and Strategy). To gage your progress, take this exam before using ER-28, then again after using it for a period of time. All questions are multiple-choice, and more than one choice may be part of a fully correct answer. Carefully read each question and all choices before making your selection(s) and submitting your answer.” The exam results text can also be displayed alongside the clinical baseline examination test text.

A sample question such as exam question one 157 can be phrased as, “She denies any shortness of breath or facial swelling. She has no significant past medical history. She denies any new medications/she states that she has had reactions to “pollen” in the past. You diagnose urticaria. True statements include: frequently occurs without pruritus; most commonly occurs with stridor; commonly presents with flat, raised, pale lesions.” In this case, the exam question is a multiple-choice question that asks the user to identify all of the true statements by checking the box corresponding to the true statement. A box can be provided on the screen having a pair of states, a checked state and an unchecked state. The user can toggle the state of the box by tapping on the screen if the application is implemented on a touchscreen.

A previous quiz question text 161 can be, “ . . . red, dull tympanic membrane. True statements regarding the diagnosis include: Tragal tenderness excludes Otitis Externa; the most common etiology is group D Streptococcus; treatment of Otitis Externa rarely includes oral antibiotics; tympanic membrane perforations generally do not resolve without intervention.” The quiz question would have multiple choices asking the user to identify all of the true statements. The user can activate a “submit answer” or “next” button to navigate back to the exam question one 157.

The exam complete text 158 can be presented to the user after the quiz as, “You have reached the end of the ER-28 clinical baseline exam. You can go back, review and resubmit any of your answers. When you are finished, return to this page and submit this exam.” The application may allow the user to save the exam results or to submit the exam results such as by email.

Information regarding medical conditions can be presented on medical information pages that have been categorized and arranged according to medical complaints, also called medical issues. For example, sore throat basics text 159 can read, “In adults, the vast majority of sore throats are viral and do not require any treatment. Children have higher incident of Strep Pharyngitis. Children often present with classic physical signs for viral syndromes, such as Hand, Foot, and Mouth Disease. Adolescents are at increased risk for Pharyngitis caused by Epstein Barr Virus.” The sore throat basics text 159 can be accompanied by a video of a physician. The video can be titled, “BETS protocol video.” Additional sore throat text 160 can add, “Adolescents are at increased risk for Pharyngitis caused by Epstein Virus.” The additional sore throat text 160 can be listed under sore throat basics text 159.

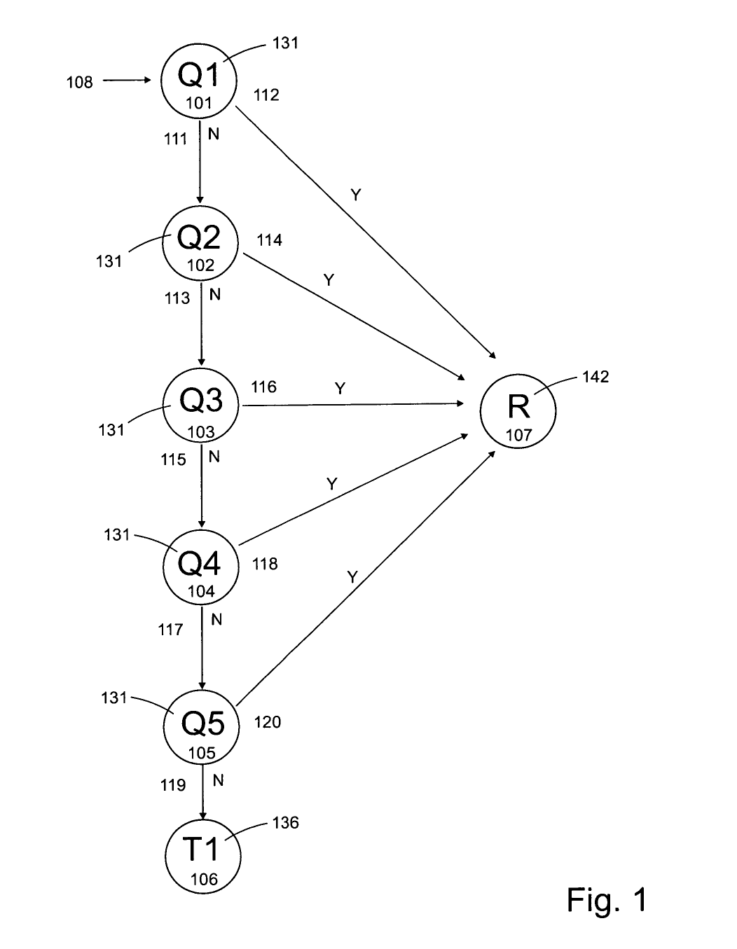

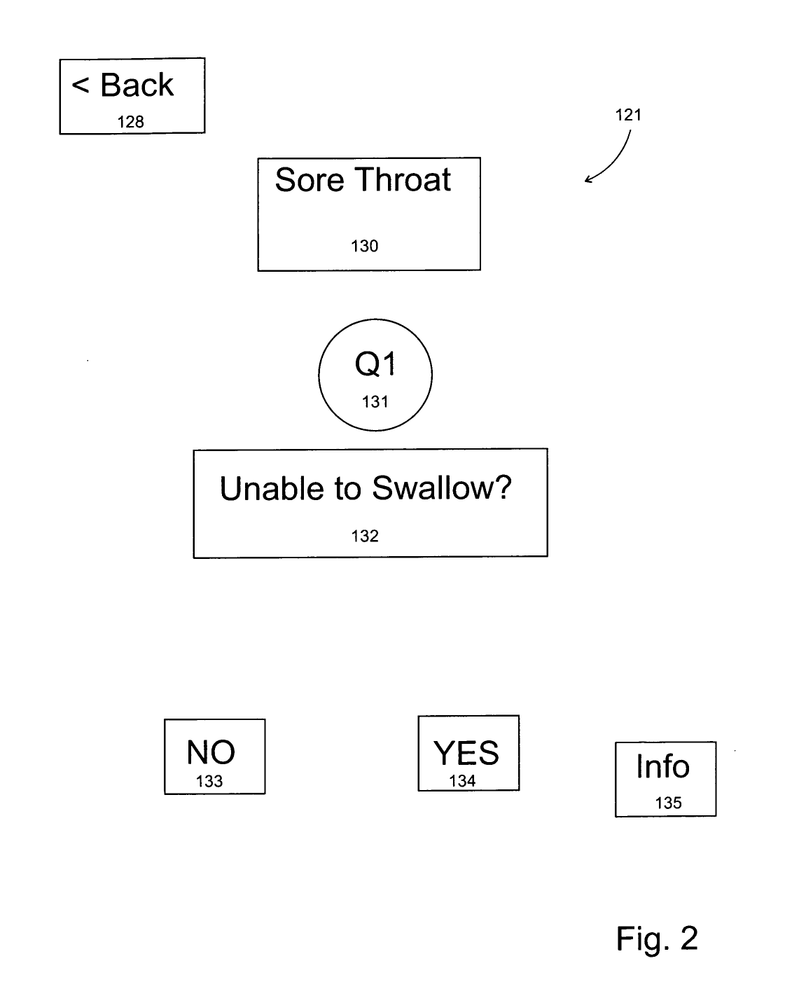

Thus, the user can access a treatment strategy by quickly tapping on a screen to select and check off various patient conditions which could be contraindications. According to FIG. 1, when the query receives the yes prompt response or the no prompt response the query automatically links to either: a next question page; a referral page; or a treatment page. The treatment page has a treatment indicator. The next question page has a next question, and the referral page has a referral indicator. The first question is Q1 and the next question after the first question is Q2. If the user answer is no 111 at the first question, the user will go to the second question Q2. The second question will be on the second question page. The referral page denoted with the letter R will have a referral protocol for a referral indicator. The treatment page denoted with T1 will have a treatment indicator or treatment information.

The first question has a first query presented as the yes button and the no button which links to a second query of a second question also having the yes button and the no button. The second query of the second question can link to a third query of a third question which also has the yes button and the no button. There can be a set number of questions, such as five questions in total. Thus, the user can sequentially answer the first question at the first query, the second question at the second query and the third question at the third query using the yes button and the no button links.

1. A decision-making aid implemented a computer application comprising:
a. a list of medical issues displayed on a medical issue list page;
b. a treatment strategy questionnaire wherein each medical issue in the list of medical issues is a link to a particular treatment strategy questionnaire, wherein the treatment strategy questionnaire includes a list of questions, wherein each question of the list of questions is displayed on a question page;
c. a prompt receiving an answer to a question;
d. a query presented as a yes button and a no button, wherein the prompt is a yes or no prompt corresponding to the yes button and the no button, wherein the yes button provides a yes prompt response, and wherein the no button provides a no prompt response;
e. a referral indicator, wherein the query is configured to display the referral indicator when a user selects a first preconfigured response to the query;
f. a treatment indicator wherein the query is configured to display the treatment indicator when a user selects a second preconfigured response to the query; and
g. a treatment information page providing medical information regarding a medical issue in the list of medical issues.

2. The decision-making aid of claim 1, wherein the list of medical issues includes a list of patient complaints.

3. The decision-making aid of claim 1, wherein the wherein the question corresponds to a contraindication.

4. The decision-making aid of claim 1, further comprising a quiz for the user, wherein the quiz is accessed through a quiz link on the treatment page, wherein the quiz is multiple-choice.

5. The decision-making aid of claim 1, wherein the query after receiving the yes prompt response or the no prompt response links to either: a next question page; a referral page; or a treatment page; wherein the treatment page has a treatment indicator, wherein the next question page has a next question, and wherein the referral page has a referral indicator.

6. The decision-making aid of claim 1, wherein the query presented as the yes button and the no button links to a second query also having the yes button and the no button, wherein the second query links to a third query which also has the yes button and the no button, wherein a user can answer the first query, the second query and the third query using the yes button and the no button links.

7. The decision-making aid of claim 6, wherein the list of medical issues includes a list of patient complaints.

8. The decision-making aid of claim 6, wherein the wherein the question corresponds to a contraindication.

9. The decision-making aid of claim 6, further comprising a quiz for the user, wherein the quiz is accessed through a quiz link on the treatment page, wherein the quiz is multiple-choice.

10. The decision-making aid of claim 6, wherein the query after receiving the yes prompt response or the no prompt response links to either: a next question page; a referral page; or a treatment page; wherein the treatment page has a treatment indicator, wherein the next question page has a next question, and wherein the referral page has a referral indicator.

11. The decision-making aid of claim 6, wherein the list of medical issues includes a list of patient complaints, wherein the wherein the question corresponds to a contraindication, wherein the query after receiving the yes prompt response or the no prompt response links to either: a next question page; a referral page; or a treatment page; wherein the treatment page has a treatment indicator, wherein the next question page has a next question, and wherein the referral page has a referral indicator.

12. The decision-making aid of claim 11, further comprising a quiz for the user, wherein the quiz is accessed through a quiz link on the treatment page, wherein the quiz is multiple-choice.
